(19) United States
(12) Patent Application Publication
(10) Pub. No.: US 2003/0093515 A1
(43) Pub. Date: May 15, 2003

(54) Quality of service control of streamed content delivery

(76) Inventor: Marc W. Kauffman, Encinitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/002,469

(22) Filed: Nov. 14, 2001

(51) Int. Cl. G06F 15/173

(52) U.S. Cl. 709/224; 709/231

(57) ABSTRACT

According to the invention, a method for distributing a content object over a broadband connection to an end-user location is disclosed. In one step, an amount of bandwidth for adequate quality of service (QOS) to transport the content object is determined. A period for transporting the content object is also determined. A check for availability of the amount of bandwidth to the end-user location over the period is performed. If available, the bandwidth is reserved. The content object is streamed to the end-user location.

### BACKGROUND OF THE INVENTION

This invention relates in general to streamed content delivery and, more specifically, to streaming audio or video content originating across a wide area network.

Currently, audio and video is streamed from the Internet to a computer using proprietary formats and transport protocols to proprietary players that are available from Microsoft™, Apple™ and Real Media™. There are also standard transport protocols such as those defined with MPEG-4 and RTSP/RTP that may be used with some proprietary players. The players run on computers such that a user can listen to audio or watch video streamed from a content provider. Cable modems, DSL modems and other broadband modems interface the computer to the Internet to allow reception of the content streams. Because of the so-called digital-divide, families that cannot afford computers and Internet connections cannot take advantage of audio and video over the Internet.

As part of a cable television subscription, many homes today are provided with cable system set top boxes for little or no additional cost to the consumer. Many of the set top boxes, such as the DCT-2000™ available from Motorola™, allow decoding and displaying programs sent in MPEG-2 format using MPEG-2 transport protocols. Program feeds or tapes are supplied to the headend of the cable operator for distribution to the set top boxes using a hybrid fiber/cable (HFC) plant. The programs are provided in a linear schedule such that the user can select any program for viewing.

Telephone companies are beginning to offer very high speed digital subscriber line (VDSL) service to consumers. VDSL provides an approximately 6 Mbps connection to computers and set top boxes. The computers use the bandwidth to connect to the Internet and the set top boxes use the bandwidth to provide video programs from a linear schedule or in a video on demand (VOD) menu along with services such as VOD. Users of the VDSL set top boxes are limited to selecting programs from the linear schedule or VOD menu.

### BRIEF DESCRIPTION OF THE DRAWINGS

The present invention is described in conjunction with the appended figures:

FIG. 1A is a block diagram of an embodiment of a content distribution system;

FIG. 1B is a block diagram of another embodiment of a content distribution system that uses video digital subscriber line (VDSL) technology;

FIG. 2A is a block diagram of an embodiment of a hybrid fiber/coax (HFC) plant interfaced with a headend and content receivers;

FIG. 2B is a block diagram of an embodiment of a hybrid fiber/twisted pair (HFTP) plant interfaced with a point of presence and content receivers;

FIG. 3A is a block diagram of an embodiment of a portion of a headend, which is coupled to content receivers with the HFC plant;

FIG. 3B is a block diagram of an embodiment of another portion of the headend, which is coupled to set top boxes;

FIG. 3C is a block diagram of another embodiment of a portion of the headend, which is coupled to set top boxes;

FIG. 4A is a block diagram of a prior art unassociated content provider;

FIG. 4B is a block diagram of an embodiment of an associated content provider;

FIG. 5A is a block diagram of an embodiment of a content exchange;

FIG. 5B is a block diagram of another embodiment of the content exchange that includes transcoding capability;

FIG. 6A is a block diagram of an embodiment of an associated client computer;

FIG. 6B is a block diagram of an embodiment of an enhanced set top box;

FIG. 6C is a block diagram of an embodiment of a standard set top box that can tune to a channel package for viewing;

FIG. 7 is a flow diagram of an embodiment of a process for streaming a content object to a standard set top box;

FIG. 8 is a flow diagram of an embodiment of a process for streaming a content object to a content receiver; and

FIG. 9 is a flow diagram of an embodiment of a process for controlling quality of service for a streamed content object.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DESCRIPTION OF THE SPECIFIC EMBODIMENTS

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set for in the appended claims.

The present invention allows controlling quality of service (QOS) for the so-called “last mile” of content delivery. For example, a set amount of bandwidth is reserved between the headend and a content receiver. The reservation avoids oversubscription of the last mile such that a desired QOS is interrupted. Where a reservation is not possible, the content object may be transcoded to a lower datarate or buffered.

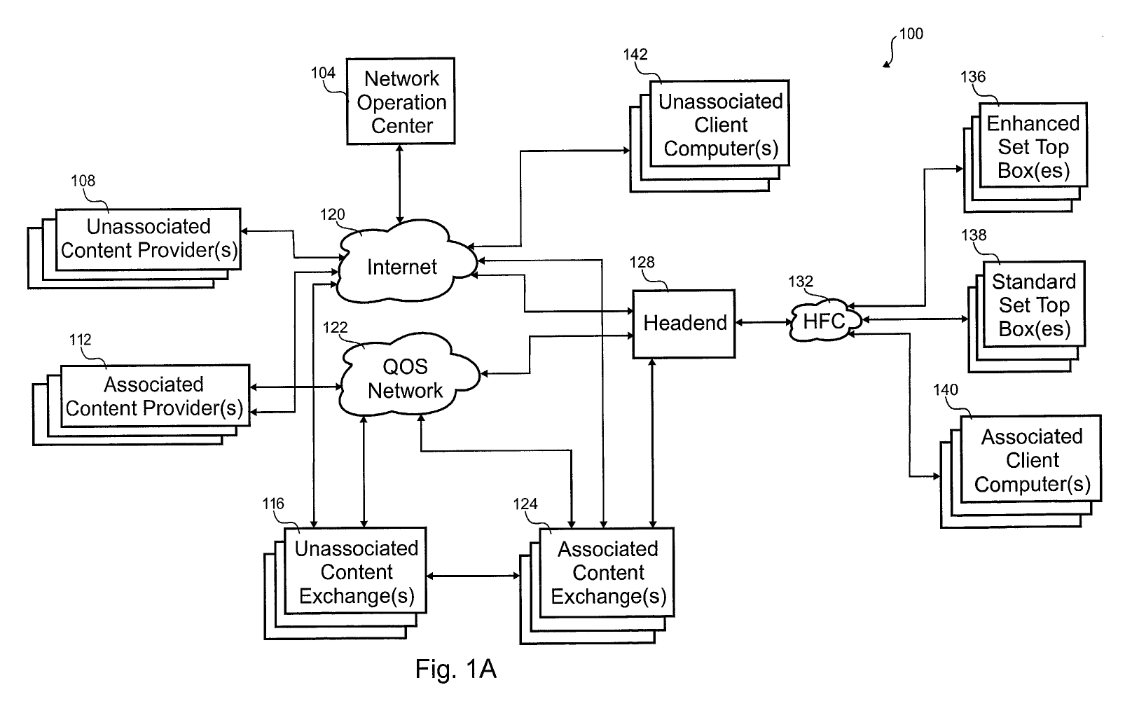

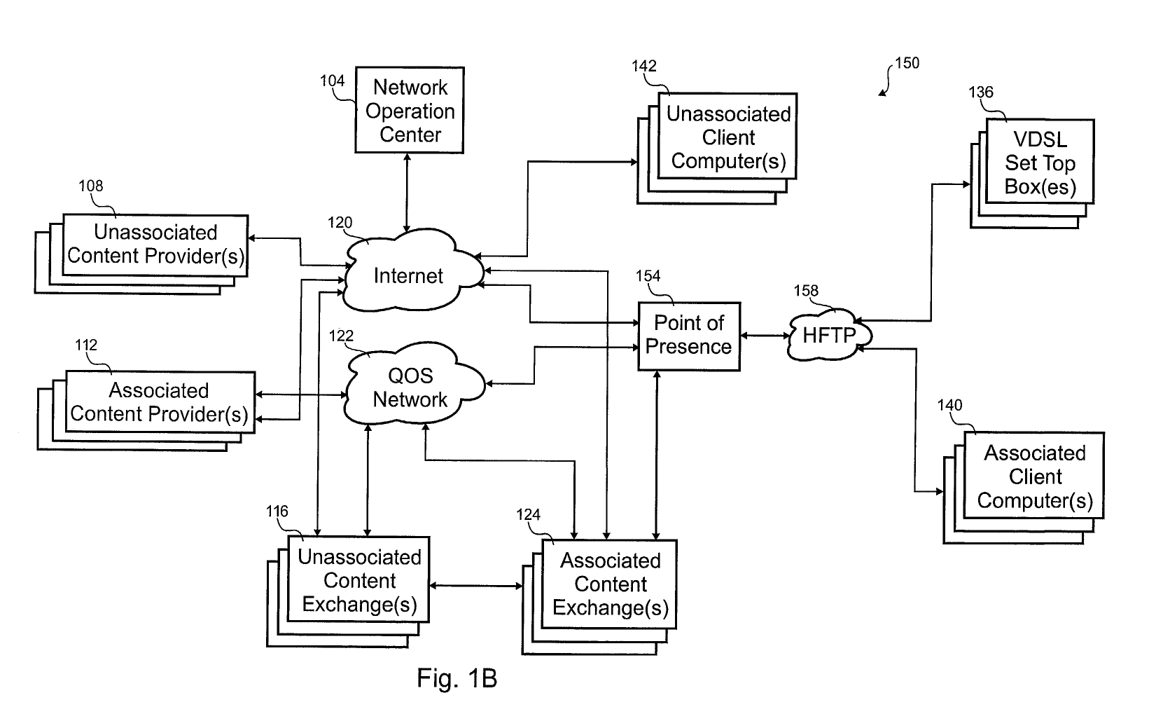

Referring initially to FIG. 1A, a block diagram is shown of an embodiment of a content distribution system 100. In this embodiment, a cable television (TV) system is used to distribute content objects to users. Content objects from either unassociated content providers 108 or associated content providers 112 may be distributed through the Internet 120 or a quality of service (QOS) network 122. Both unassociated and associated content exchanges 116, 124 allow cacheing of content objects before transport of the objects through a headend and hybrid fiber/coaxial plant 132 to the user. Viewing of or listening to the content object is provided by one of a standard set top box 138, an enhanced set top box 136 and an associated client computer 140.

The network operation center 104 provides many functions used by the system 100. Associated client computers 140 sign-up and download viewer object proxy and other software from the network operation center 104. Some billing and logging for the system 100 is also performed in the network operation center 104. Directory information for the system 100 is maintained in the network operation center 104 such that users can see the various content objects registered in the system 100. Requests for those registered objects are routed to the appropriate content provider 108, 112 who originated the content object. Encryption key distribution and management are also performed by the network operation center 104.

A content object can originate from either associated or unassociated content providers 112, 108. Unassociated content providers 108 include any computer visible from the Internet 120 that supplies content objects that are streamable. Associated content providers 112 have the ability to use the QOS network 122 in addition to the Internet 120. Further, the associated content providers 112 can route a content object query to various content exchanges 116, 124 for better QOS and can publish directory information to the network operation center 104.

Content exchanges 116, 124 source content objects to users to provide enhanced QOS. When a content object is requested from a content provider 108, 112, either the content provider 108, 112, the network operation center 104 or the viewer object proxy may redirect that request to a content exchange 116, 124 for fulfillment. Under some circumstances, the associated content provider 112 may choose to fulfill the request itself rather than passing fulfillment to a content exchange 116, 124. Content objects requested from content exchanges 116, 124 are located by first, searching the content exchange 116, 124; second, searching other interconnected content exchanges 116, 124; and, third, a request to the originating content provider 108, 112.

Unassociated content exchanges 116 are available to any user in the system 100, but associated content exchanges 124 primarily benefit any enhanced set top box (STB) 136, standard STB 138 or associated client computer 140 linked to those associated content exchanges 124. With the proper software, unassociated client computers 142 can receive content objects from the unassociated content exchanges 116.

Receiving a content object at a desired data-rate that does not exceed the data-rate of the client computer's connection to the Internet 120 is defined as adequate QOS. The maximum QOS a user can expect is defined by the speed, delay, jitter and error rate of their network connection, the processing power of their computer and other factors. The minimum QOS is subjectively defined by the user based upon the quality they desire within certain limits. For example, a user with a 400 Kbps network connection and a fast computer may have a choice of a 28 Kbps, 56 Kbps, or 128 Kbps stream for an audio clip from which the user chooses the 128 Kbps stream. So long as the datarate provided to the client computer is in the range of 128-400 Kbps, adequate QOS is possible for that stream.

Typically, an associated content exchange 124 is tightly integrated with a particular headend 128 to provide low latency and fewer hops between the associated content exchange 124 and a content receiver. In this way, the associated content exchange 124 is usually the highest QOS source of a content object for the user. Each associated content exchange 124 is assigned to a group of content receivers associated with the headend 128. The content objects sourced by the users of the content receivers are stored in the associated content exchange 124 along with any content objects they request. Associated content exchanges 124 provide their content objects or portions thereof to other content exchanges 116, 124, however, associated content exchanges 124 do not normally stream content objects not originating from its users to unassociated client computers 142.

The cable operator aggregates network traffic and MPEG-2 transported content objects in the headend 128. For example, a cable operator of a large metropolitan area may have one or more headends 128. Network traffic is sent to and received from a wide area network, which is defined to include the Internet 120 and/or the QOS network. The headend 128 interfaces with the Internet 120 and QOS network 122 to send and receive network traffic. Other program feeds are used by the headend to provide a linear schedule of programs to each STB 136, 138. The HFC plant 132 transports the program feeds and network traffic to each STB 136, 138 and each associated client computer 140.

Each set top box 136, 138 receives channel packages of elementary streams in MPEG-2 format with MPEG-2 transport. In MPEG-2 transport, programs are separated into constituent parts or elementary streams and compressed into packets with timestamps for transport in a multiplexed datastream. The multiplexed datastream may include a number of different MPEG-2 program parts for various channel packages distinguished in the datastream by program identifiers (PIDs). By filtering for the PIDs the elemenary stream, channel package is gathered and aligned, where the time stamp is used for alignment. The datastream is transported in an analog TV channel on a carrier signal.

In the above embodiment, the content providers 108, 112 are located remotely to the content exchanges 116, 124. Some embodiments could co-locate the content providers 108, 112 and content exchanges 116, 124. An intranet could link them together.

With reference to FIG. 1B, a block diagram of another embodiment of a content distribution system 150 is shown that uses video digital subscriber line (VDSL) technology. VDSL uses a high bandwidth data link to send and receive data that could include video channels, phone conversations and/or Internet traffic. A point of presence 154 performs the functions of a headend 128 and communicates with VDSL set tops 136 and associated client computers 140. A hybrid fiber/twisted pair (HFTP) plant 158 is used for the VDSL data channel and may include fiber and/or twisted pair wire to convey the data where some embodiments could be all twisted pair or all fiber.

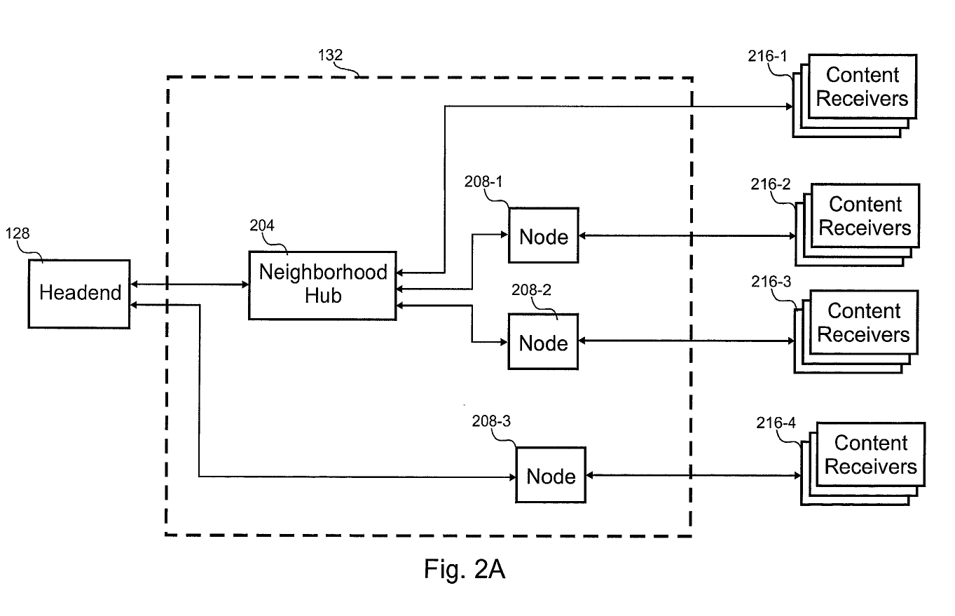

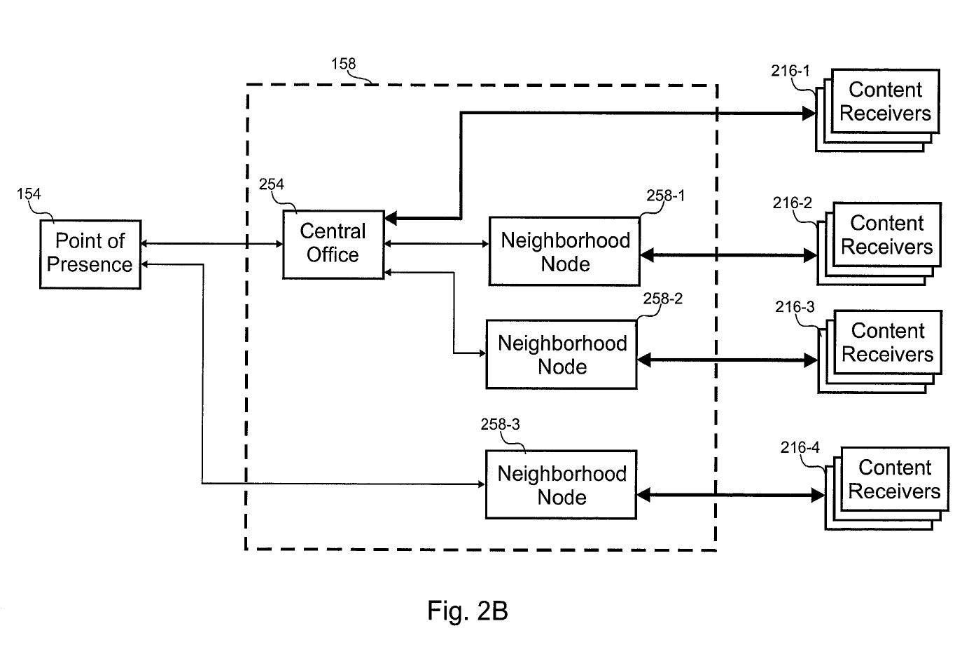

Referring next to FIG. 2A, a block diagram of an embodiment of a HFC plant 132 is shown interfaced with the headend 128 and content receivers 216. In this embodiment, the content receivers 216 could include the enhanced STBes 136, the standard STBes 138 and the associated client computers 140. The HFC plant 132 can include a multitude of different configurations to support a unique menu channel for each standard STB 136. The unique menu channel allows the user to choose content objects from a directory supplied by the network operation center 104 or could allow web browsing to find content objects. The menu channel is formulated in the headend 128 and supplied by the HFC plant to the user who can interact with the menu channel to select content objects.

Included for this embodiment of the HFC plant 132 are a neighborhood hub 204 and a number of nodes 208 that receive their content objects from optical fibers. Nodes 208 typically serve around 500 users and interface the optical fibers to coaxial cables. Neighborhood hubs 204 typically serve around 10,000-20,000 users and do the same interfacing of optical fibers to coaxial cables as the nodes 208, but may also include an associated content exchange 124. Further, the neighborhood hubs 204 may serve optical fiber connections to nodes 208. The coaxial cable from either a neighborhood hub 20 or node 208 to a group of content exchanges 216 share a set amount of bandwidth in such a manner that the QOS can be greatly reduced by oversubscription.

With reference to FIG. 2B, a block diagram of an embodiment of a HFTP plant 158 interfaced with a point of presence 154 and content receivers 216 is shown. In this embodiment, the content receivers 216 include VDSL STBes 136 and associated client computers 140 that receive their IP traffic from a twisted pair phone line. Each content receiver 216 gets its own twisted pair conductor from either the central office 254 or neighborhood node 258. Optical fiber feeds the neighborhood nodes 258 and central offices 254. Typically, the central office 254 would include an associated content exhange 124.

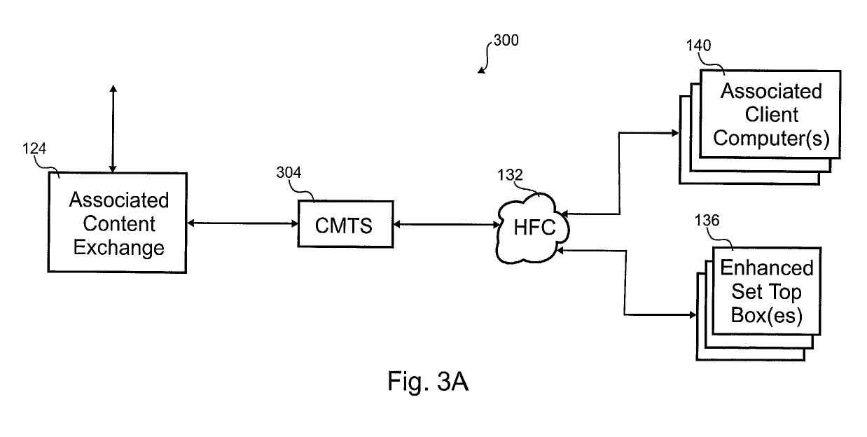

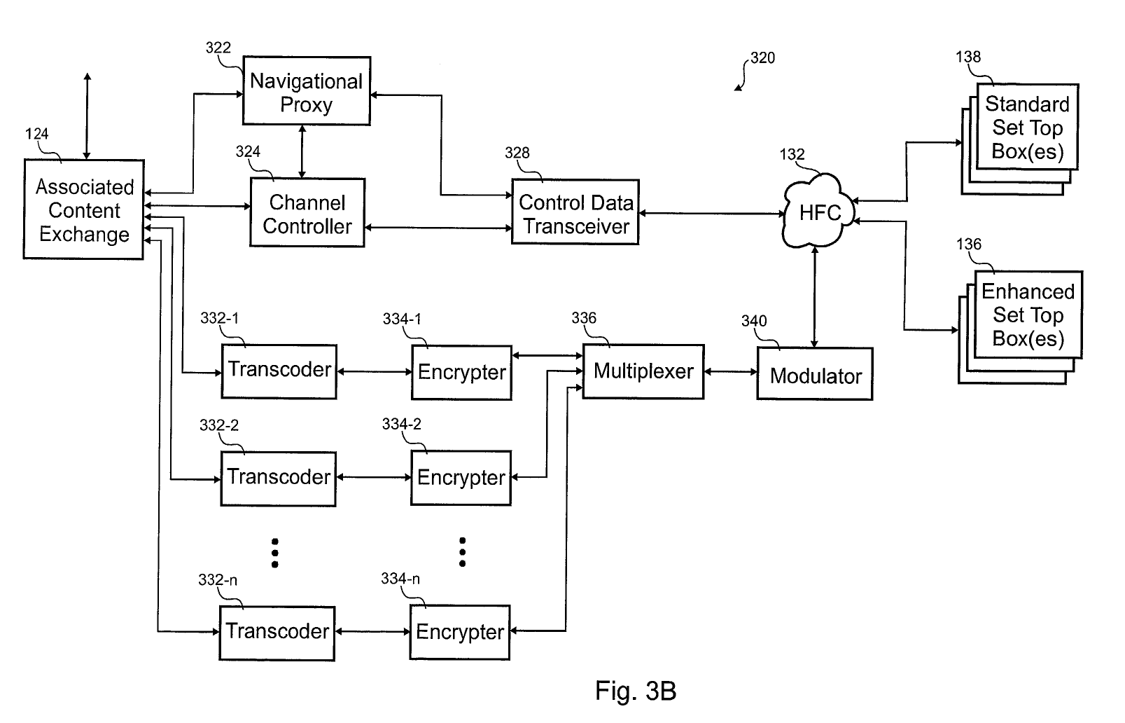

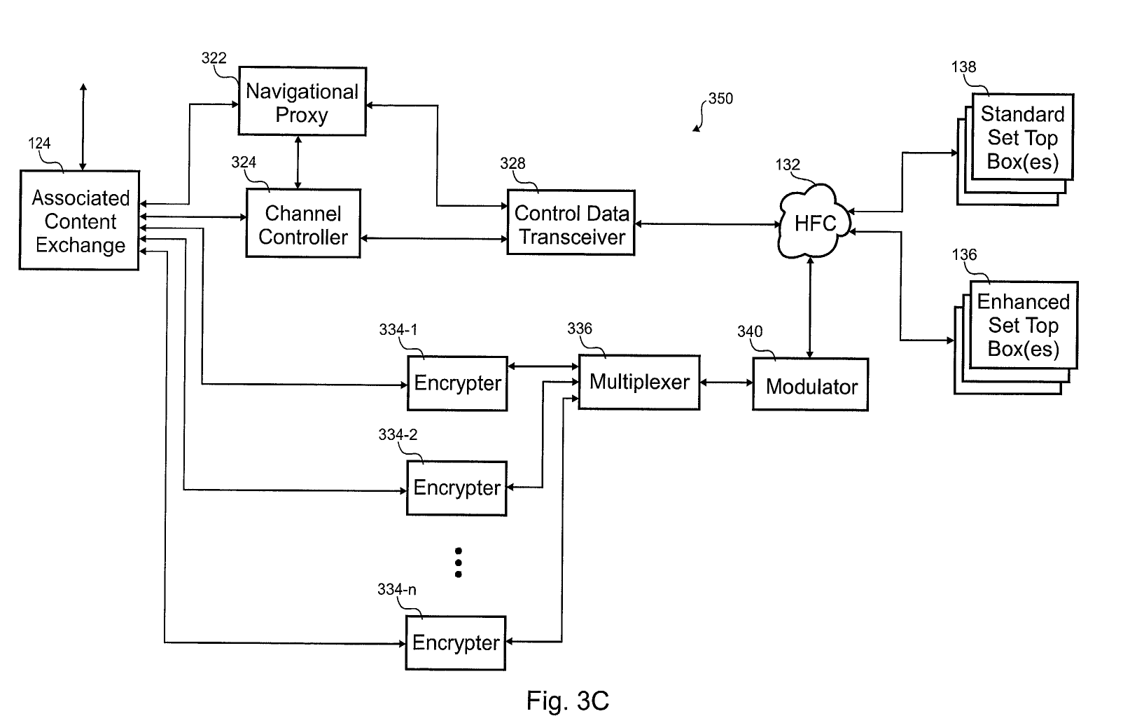

Referring next to FIG. 3A, a block diagram of an embodiment 300 of a portion of a headend 128 coupled to content receivers with the HFC plant 132 is shown. The associated content exchange 124 is coupled to a cable modem termination system (CMTS) 304. The depicted embodiment 300 routes network traffic that is IP packet based. The enhanced STBes 136 of this embodiment behaves like a client computer 140 to allow browsing and to run player software. Some embodiments may have multiple associated content exchanges 124 and/or multiple CMTS with a router to direct network traffic between them. Additionally, a single headend 128 could serve any number of HFC plants 132.

The CMTS 304 includes a router to allow routing traffic to the appropriate enhanced STB 136 or associated client computer 140 by way of a DOCSIS or other cable modem. Data is modulated onto and demodulated off the HFC plant 132 by the CMTS. The CMTS also controls media access and other configuring for the DOCSIS cable modems. Reservations for bandwidth are made with the CMTS to guarantee a particular data rate or QOS between the associated content exchange 124 and content receiver 136, 140. Where a reservation is not possible, the datalink between the CMTS 304 and a content receiver 216 may proceed in a best efforts mode where any non reserved bandwidth is shared among many content receivers 136, 140 sharing a common datachannel.

With reference to FIG. 3B, a block diagram of an embodiment 320 of another portion of the headend 128 is shown coupled to set top boxes 136, 138. This embodiment 320 uses MPEG-2 formatted content objects transported in a multiplexed MPEG-2 data stream carried in a TV channel to each STB 138, 136. The enhanced STB 136 of this embodiment 320 can receive content objects from either the DOCSIS port or the MPEG-2 datastream.

In the case where the STB 136, 138 receives content objects through the MPEG-2 datastream, the navigational proxy 322 provides a menu channel for that purpose. The menu channel can be a list or grid showing available content objects or can be a web browser interface that allows selecting any content objects even if those content objects are not registered with the system 100. By having the menu or browser functionality in the navigation proxy 322 instead of the STB 136, 138, the footprint of the client software for the STB 136, 138 may be reduced. Requested content objects are downloaded to the associated content exchange 124 for buffering and/or cacheing before being streamed in a MPEG-2 datastream.

Once the content object is ready for streaming in the associated content exchange 124, the channel controller 324 configures the MPEG-2 transport to the STB 136, 138 such that the content object is transported in a channel package of elementary streams. To accomplish the transfer, the content object is routed to a transcoder 332 and encrypter 334 corresponding to a chosen channel package. The multiplexer 336 and modulator 340 are used to combine a number of channel packages together into a multiplexed datastream and modulate that datastream onto a carrier frequency for the selected TV channel. The channel controller 324 communicates the index of PIDs for the elementary stream and the selected TV channel to the client on the STB 136, 138 by way of a control data transceiver 328 such that the content object can be received and decoded. The channel controller 324 also records usage by STB 136, 138 such that costs associated with the service can be determined. In various embodiments, the usage could be determined based upon the number of reservations made, the amount of bandwidth reserved, the length of the reservation, and/or the portion of the reserved bandwidth that was used.

The transcoder 332 does any required format conversion on the content object. Format conversion may include changing the bit rate and/or the encoding for the content object. For example, the associated content exchange 124 could store a content object that is Quicktime™ encoded at 1 Mbps and the transcoder 332 could convert the content object to a MPEG-2 encoding at 400 Kbps. In this embodiment, some of the set top boxes 138 can only decode content objects in MPEG-2 format so most content objects are transcoded into MPEG-2 format.

The encrypter 334 scrambles a channel package such that it can only be decoded by the STB 136, 138 with the proper key. Although many STBes 136, 138 may receive the channel package, only the one(s) with the key can decode and view the program. Control through encryption allows conditional access of the content object. In some embodiments, encryption is not activated or keys are given to multiple STB 136, 138 such that many can play the content object.

Referring next to FIG. 3C, a block diagram of another embodiment 350 of the portion of the headend 132 is shown coupled to the standard set top box 136, 138. This embodiment does not have external transcoders 332. Any transcoding in this embodiment could be performed on a content exchange 116, 124 or at the content provider 108, 112.

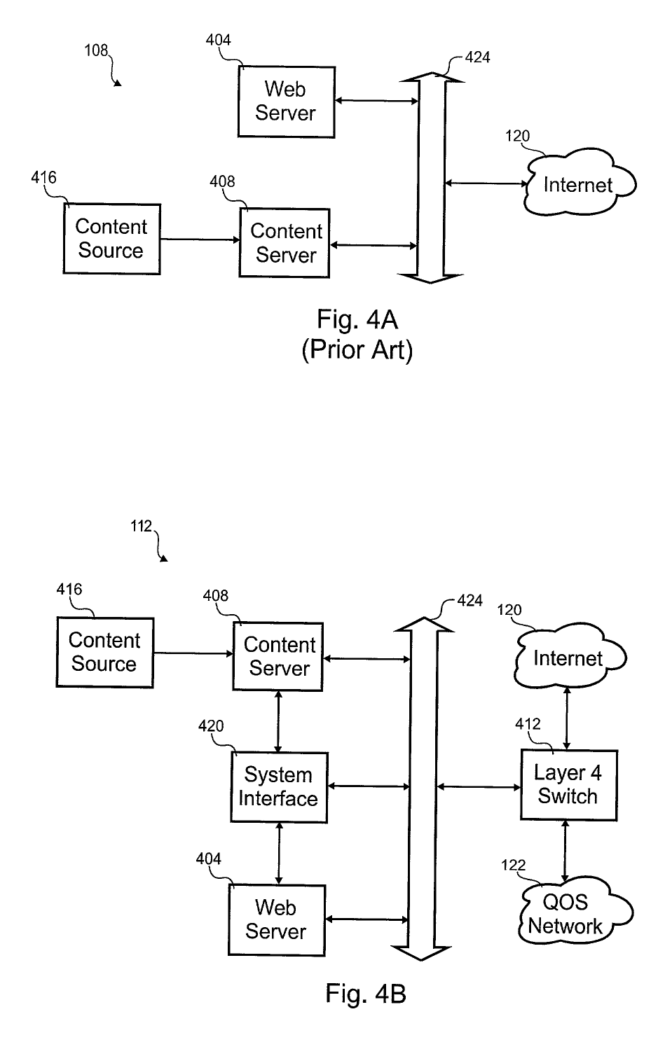

Referring next to FIG. 4A, a block diagram of an unassociated content provider 108 is shown. The unassociated content provider 108 is simply any web site on the Internet 120 that serves web pages from a web server 404 that includes streamable content objects. The content objects are stored on a content server 408 and originate from a content source 416. The content source 416 could be a web cam, tape drive or any other mechanism for loading a content object. The web server 404, content server 408 and Internet 120 are all coupled together with a backbone 424.

With reference to FIG. 4B, a block diagram of an embodiment of an associated content provider 112 is shown. This embodiment adds functions to allow the content objects to be cataloged by the system 100 and to allow routing the content receivers 216 to a content source with adequate QOS for fulfillment of a request for a content object.

The Internet 120 and the QOS network 122 interface to a layer 4 switch 412. Requests to the web server 404 are redirected to the system interface 420 by the layer 4 switch 412. The system interface 420 requests the web page from the web server 404 and rewrites the content object links in the web page before presentment to the content receiver 216. The links are rewritten based upon the system interface 420 knowing where the content objects are distributed among the content exchanges 116, 124 and/or knowing which content exchanges 116, 124 are preferred by the content receiver 216.

Once the content receiver is redirected to a content exchange 116, 124 for fulfillment of the request for the content object, the content exchange 116, 124 may request the content object or portions thereof from the associated content provider 112 if no other content exchanges 116, 124 have the content object or portions thereof. Any request to the associated content provider 112 for the content object is intercepted by the system interface 420. After the system interface requests the content object from the content server 408, it may be processed by the system interface 420. The system interface 420 may transcode the content object to different coding formats or bitrates as it is streamed or all-at-once before streaming. Additionally, the content object may be encrypted to avoid illicit interception before reaching the content exchange 124.

The system interface 420 also supplies directory information to the network operation center 104. When content objects are added, removed or otherwise become unavailable on the content server 408 and/or at predetermined intervals, the system interface 420 reports that directory information back to the network operation center 104. A dynamic directory is maintained in the network operation center 104 that is constantly updated by the reports from the associated content providers 112. The directory may be used in generating the directory menu channel or may be browsed to determine the registered content objects available for streaming by the system 100.

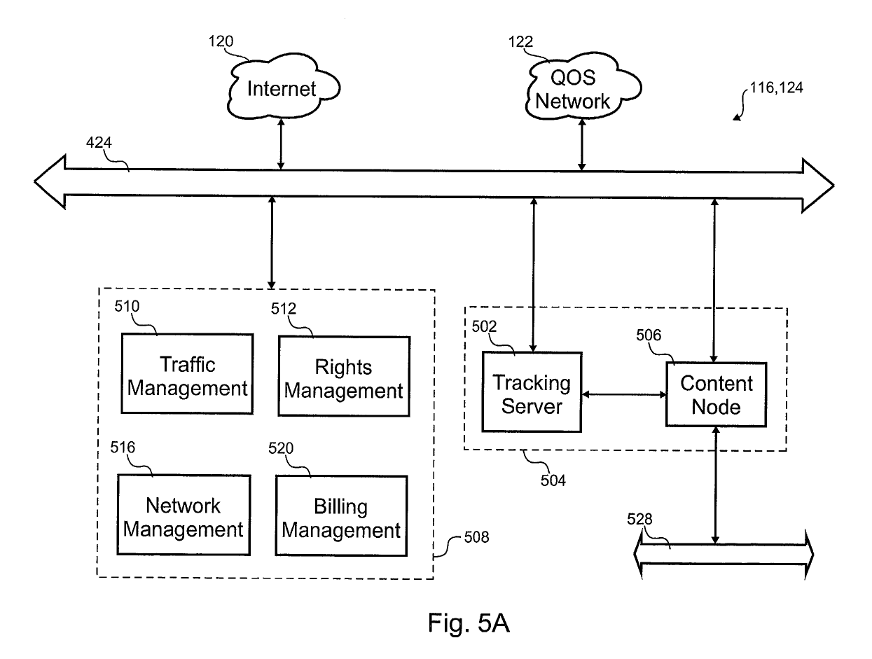

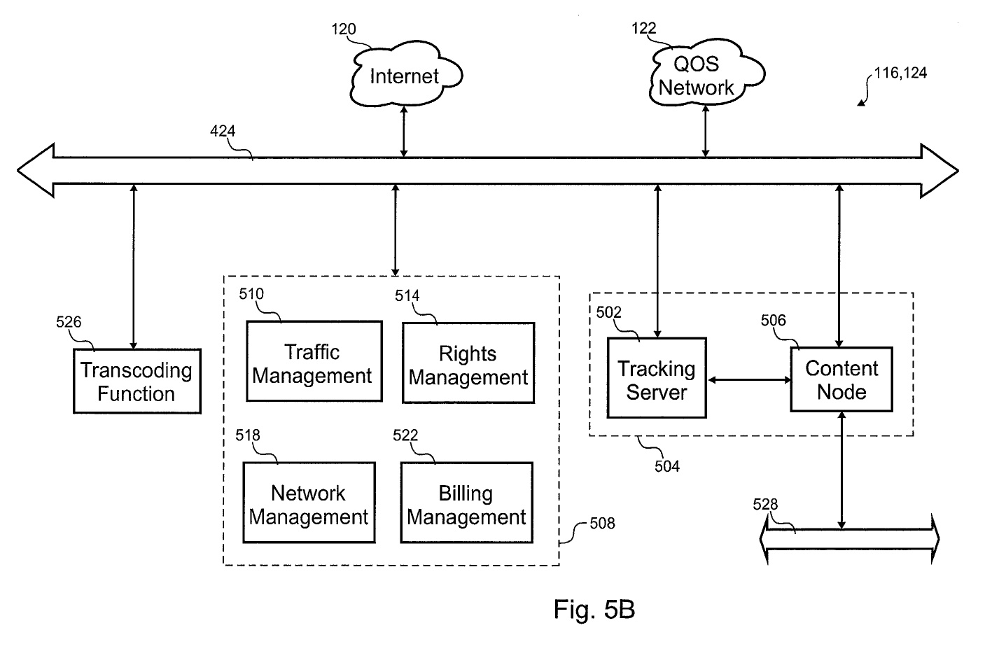

With reference to FIG. 5A, a block diagram of an embodiment of an unassociated or associated content exchange 116, 124 is shown connected to both the Internet 120 and the QOS Network 122 by way of the backbone 424. The content exchange 116, 124 includes a cache node 504 and a software subsystem 508. The cache node 504 is part of a distributed network of content exchanges 116, 124 interconnected by a high-speed link 528. This high-speed link 528 could include satellite, microwave, optical fiber, Internet, or other network technologies to allow quick sharing of content objects or portions thereof.

The cache node 504 stores content objects and portions thereof for spooling to multiple users. Buffering is provided even if multiple users do not request the content object. Included in the cache node 504 are a tracking server 502 and a content node 506. The content node 506 stores content objects in a cache or a file system and requests missing portions of a content object from other content exchanges 116, 124. Where the content object cannot be found in any of the content exchanges 116, 124, the tracking server 502 is used to get the content object from the content server 108, 112.

The tracking server 502 determines the content objects stored in the content node 506. Additionally, a list of all associated content providers 112 is maintained by the tracking server 502. All the associated content providers 112 are periodically notified by the tracking server 502 of which content objects are currently cached such that the associated content provider 112 knows where all its content objects are stored in the system 100. The tracking server 502 makes queries to the network operation center 104 to determine which content object portions in the content node 506 or requested by the content node 506 originated from which content providers 108. Health check information is also maintained in the tracking server 502.

Access to content objects may be controlled for billing, among other, purposes. The rights management application 512 manages conditional access to the content object. Conditional access is used to prevent others from using a content object that is not free to distribute. The traffic management application 510 tracks usage by content receiver 216. In various situations, either the user, the content provider or other parties are billed for the content object. The billing management application 520 works with the rights management and traffic management applications 512, 510 to bill the appropriate parties for usage.

The network management application 516 gives the network operation center 104 the ability to manage the content exchange 124 and otherwise collect information. The network management application 516 may track health information and utilization for network maintenance and other purposes. Also, billing information and rights information may be monitored and reported to the network operation center 104 by the network management application 516.

Referring next to FIG. 5B, a block diagram of another embodiment of the content exchange 116, 124 with transcoding capability is shown. The transcoding function 526 could include hardware and/or software to perform transcoding of bit rates and coding formats for content objects. This processing could be performed while streaming the content object or before a content object is streamed. For example, a VOD movie could be distributed in Quicktime™ format with a 2 Mbps datarate which is transcoded to MPEG-2 format at a 1 Mbps datarate for distribution to a STB 136, 138.

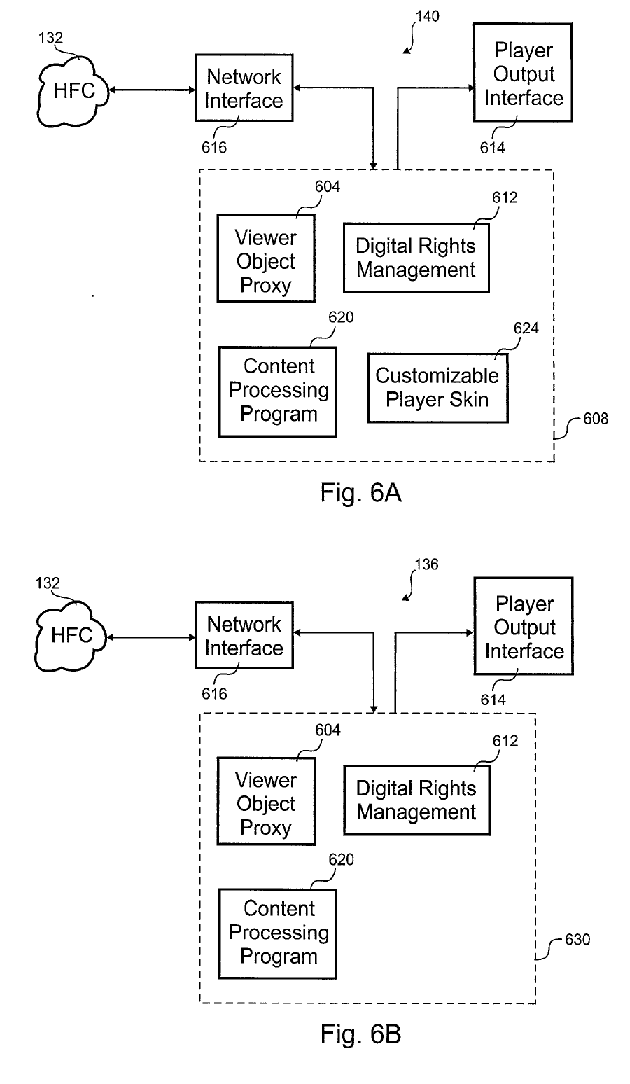

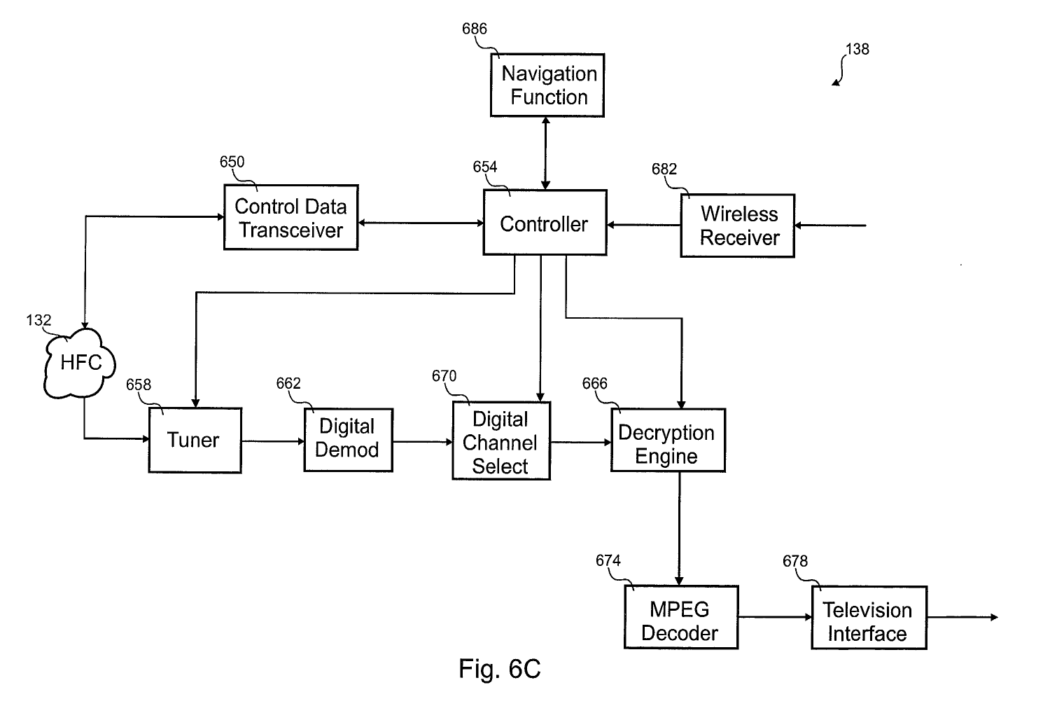

With reference to FIG. 6A, a block diagram of an embodiment of an associated client computer 140 is shown. A network interface 616, such as a cable modem, connects the associated client computer 140 to the HFC plant 132 to send and receive IP packet information. A viewer object proxy 604, a content processing program 620, a digital rights management function 612, and a customizable player skin 624 all run in an application layer 608. The video and/or audio associated with the content object is sent to a player output interface 614 which could include a video function and/or audio function.

The viewer object proxy 604 interfaces with the network interface 616 to determine QOS for content exchanges 116, 124. Suitable content exchanges 116, 124 are ranked in a list and that list is maintained until it is requested by an associated content provider 112. Typically, any associated content exchange 124 would be at the top of the ranked list. Where content objects are sourced from places other than an associated content exchange 124, the unassociated content exchange 116 may receive some compensation.

The digital rights management function 612 works with the content objects to protect copyrighted content objects from unauthorized use. Content objects authorized for use are played by the content processing program 620. Examples of content processing programs 620 include Windows Media Player™, Real Player™, etc. The customizable player skin 624 overlays the content processing program 620 to change the look and feel.

Referring next to FIG. 6B, a block diagram of an embodiment of an enhanced STB 136 is shown. This enhanced STB 136 operates in a mode similar to the associated client computer 140 of FIG. 6A where an IP packet datalink transports the content objects by way of a DOCSIS modem that may be embedded in the enhanced STB 136. Although not shown in this embodiment, the enhanced STB 136 could also receive content objects from channel package of elementary streams sent on an MPEG channel. This embodiment, does not include a customizable player skin 624, but other embodiments could include one.

With reference to FIG. 6C, a block diagram of an embodiment of a standard set top box 138 is shown that can tune to TV channel for decoding a multiplexed datastream with a channel package for a content object to play that content object. This embodiment receives control data information and datastreams embedded in TV channels or out of band channels. Other embodiments could use a DOCSIS modem or equivalent to receive control data information.

The navigation function 686 is a client application that supports receiving content objects sent as channel package of elemental streams on a TV channel arranged by the channel controller 324. Preference information for a user may also be stored in the navigation function 686 such that content objects are coded at specified data rates or streamed in various preferred modes.

Menu or browser interaction information from the user is gathered by a navigation function 686 from a wireless receiver. The user may have, for example, a keyboard that communicates with infrared to the wireless receiver 682. The menuing or browser interaction information is sent by the control data transceiver 650 back to the navigational proxy 322.

Control data information such as the channel package index is sent to a control data transceiver 650 for decoding. Once the PIDs and TV channel are known from that index, the standard STB is 138 is configured to receive the content object. The TV channel information is sent to a tuner 658 to change its receiver frequency to that channel. A digital datastream is recovered from the carrier signal in the TV channel by a digital demodulator 662. The channel package is recovered by the digital channel select circuit 670 by filtering the packets based upon PIDs. Presuming receiving the content object is authorized, a decryption engine has a key that allows decoding the channel package into plain text.

A MPEG-2 decoder 674 converts the plain text channel package into a NTSC, PAL or similar video signal. A TV interface 678 provides the video signal to an external monitor for viewing by the user. The above embodiment produces a video program on a TV, but those skilled in the art can appreciate that the invention is easily implemented for audio programs as well.

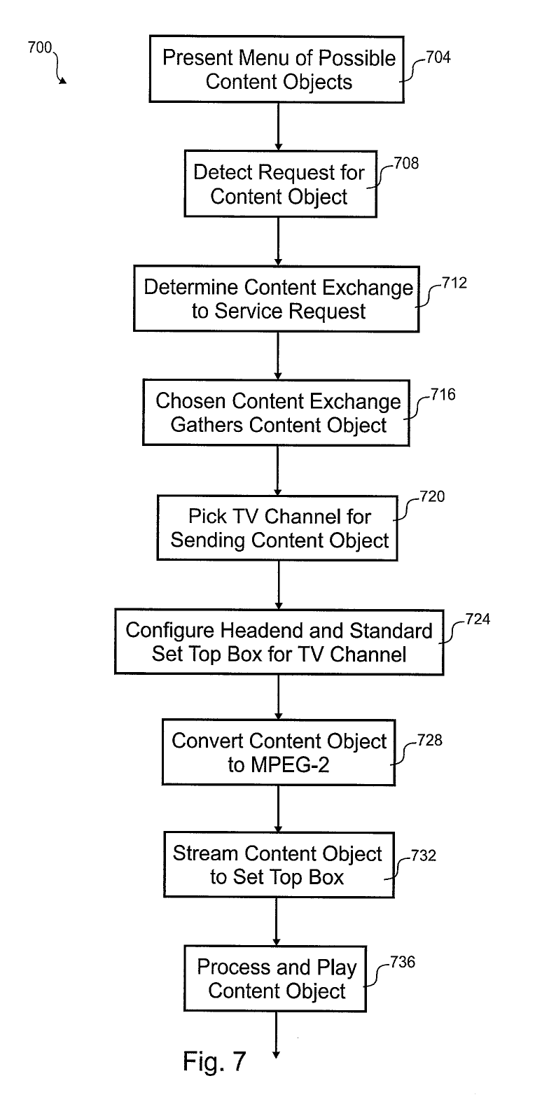

Referring next to FIG. 7, a flow diagram of an embodiment of a process 700 for streaming a content object to a standard STB 138 is shown. The depicted process picks-up in step 704 where a menu channel is presented by the navigational proxy 322 to the user with a list of possible content objects. The user uses a remote control to select one of the menu choices. The selection is detected by the wireless receiver 682 and relayed to the navigation function 686 in step 708.

In step 712, preparations are made to transport the content object to the standard STB 138. A request is made by the navigational proxy 322 to the content provider 108, 112 that originated the content object. An associated content provider 112 receives a ranking of the content exchanges 116, 124 that could source the content object, whereafter the system interface 420 redirects the request to a content exchange 116, 124 with adequate QOS.

If an unassociated content provider 116 is the source of the content object, the navigational proxy 322 redirects that request to a content exchange 116, 124 with adequate QOS. The content exchange 116, 124 that the request is redirected to will first try to find the content object locally, then request the content object from other content exchanges 116, 124, and last request the content object from the unassociated content provider 116.

The channel controller 324 arranges the transport between the headend 128 and the STB 138 in steps 720 and 724. The multiplexer 336 and modulator 340 for a TV channel with bandwidth available in the datastream for another channel package is determined in step 720. The channel package index of PIDs is communicated with the control data transceivers 328, 650 to the controller 654 in the STB 138. To receive the channel package, the controller 654 configures the STB 138 to tune to the TV channel, demodulate the datastream, filter out the channel package, decrypt that package, and display the content object.

Once the conduit between the headend 128 and the STB 138 is ready, this embodiment uses a transcoder 332 to change the coding format and/or datarate of the content object in step 728. For example, a content object in Real™ format could be changed to MPEG-2 format. As the channel package stream is converted to MPEG-2 format, it is streamed to the STB 138 in step 732. The content object is processed and played for the user in step 736. In various embodiments, the navigational proxy 322 may arrange the transcoding at either the headend 128, the content exchange 116, 124 or the associated content provider 112.

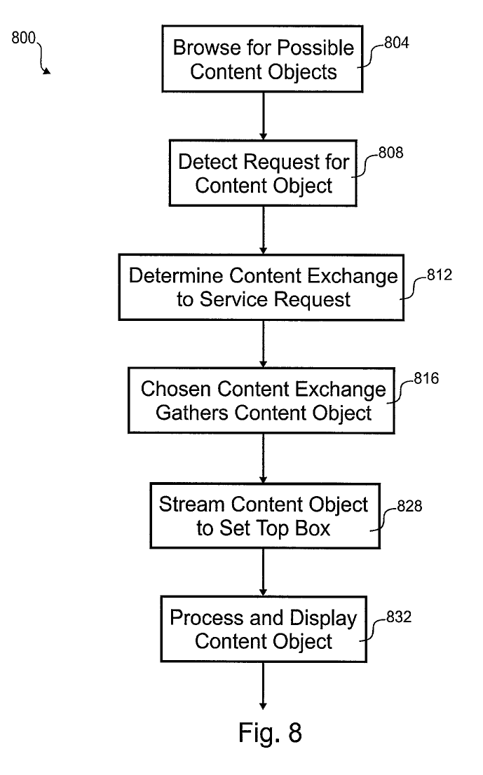

With reference to FIG. 8, a flow diagram of an embodiment of a process 800 for streaming a content object to a content receiver 216 is shown. This embodiment uses a browser interface in either the enhanced STB 136 or the associated client computer 140 to select the content object. The depicted process takes-up in step 804 where the user browses for possible content objects. The browsing may be done with the directory information stored in the network operation center 104 or could be done by browsing of content providers 108, 112 directly.

Once a content object is located by the user, the link for that object is selected. Where the content object is from an unassociated content provider 108, the viewer object proxy 604 determines the content exchange 116, 124 to redirect the request to and makes the request from that content exchange 116, 124. Alternatively, a request for a content object from an associated content provider 112 is redirected by that associated content provider 112 based upon preference information to a content exchange 116, 124 with adequate QOS.

In step 816, the selected content exchange 116, 124 gathers the content object. After a local check, the high-speed link 528 to other content exchanges 116, 124 is next used to query for any missing portions of the content object. Where peer content exchanges 116, 124 cannot locate the missing portions, a request is made back to the content provider 108, 112 that originated the content object.

Once the initial portions of the content object are found, streaming of the content object begins in step 828. The content object is streamed using IP packet transport over a broadband connection such as a satellite link, a DSL modem, a cable modem, a power line data modem, a microwave dish, cellular data modem, line-of-sight laser modem, etc. In some embodiments, a reservation may be made to guarantee an amount of bandwidth to support the stream or, alternatively, allow “best efforts” streaming of the content object. The content processing program 620 decodes and plays the streamed content object so long as the digital rights management function 612 determines viewing is authorized and provides appropriate decryption of the streamed content.

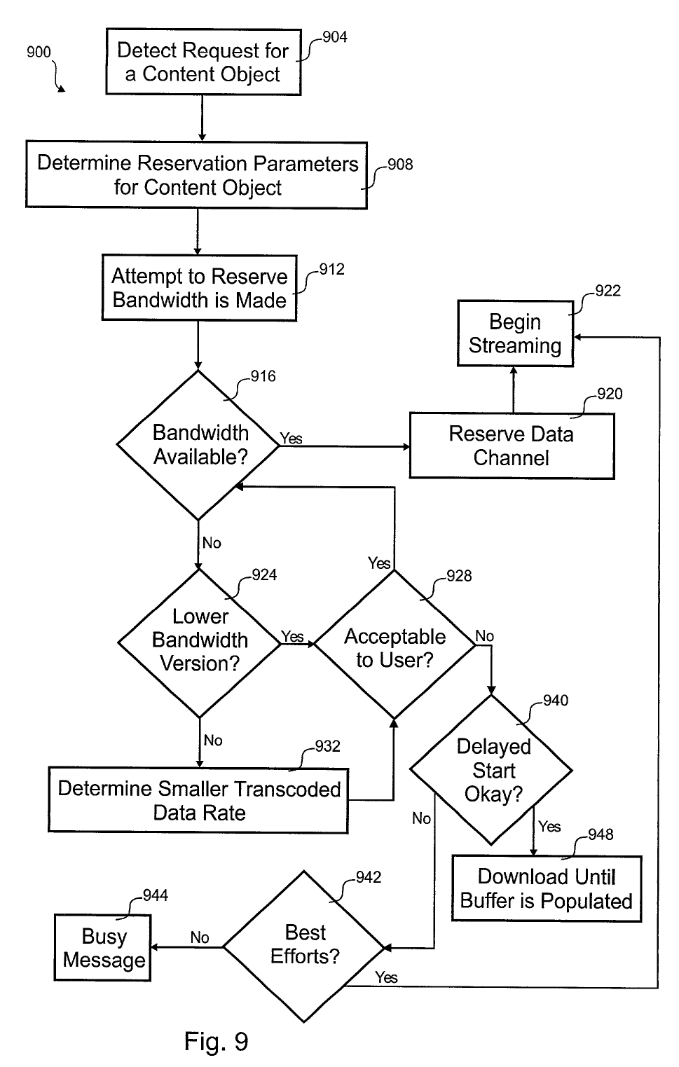

Referring next to FIG. 9, a flow diagram of an embodiment of a process 900 for controlling QOS for a streamed content object is shown. In step 904, a request for a content object is detected by the CMTS 304. The duration, format and bandwidth for the content object is determined by the CMTS 304 such that the bandwidth and duration of a data channel reservation can be discerned. An attempt is made in step 912 to reserve the data channel. If the data channel can be accommodated as determined in step 916, the data channel reservation is negotiated between the CMTS 304 and DOCSIS modem associated with the content receiver 216. The CMTS 304 and DOCSIS modem are capable of arranging a datalink that cannot normally be oversubscribed as is possible when only “best efforts” bandwidth is available.

Where the datalink cannot be reserved, an attempt to located a lower bitrate version of the content object is performed in step 924. If the lower bitrate version is available, a determination is made as to whether the lower QOS version is acceptable to the user in step 928. Preference information previously stored may be used for this determination. If the lower bitrate version is determined acceptable in step 928, processing loops back to step 916 to determine if a reservation is possible.

Returning to step 924, in some cases a lower bitrate version of the content object is not readily available. In those cases, the next smaller bit rate that could be produced by the transcoding function 526 is determined in step 932. Some embodiments could store a content object in a number of transcoded formats and datarates to anticipate the desire for different encoding. A determination is made in step 928 to see if the reduced QOS is acceptable to the user. If so, the reservation is once again attempted. Presuming the reservation is fulfilled, the transcoding is performed to comply with the reservation.

Under some circumstances, the user may be unwilling to accept a reservation with lower QOS in step 928. If so, a determination is made in step 940 to see if the user will accept a delayed start time. If accepted, a buffer in the content receiver 216 is populated with enough of the content object to overcome interruptions or bandwidth bottlenecks. In some circumstances, “best efforts” delivery may be used and a determination is made on the system 100 loading such that an appropriate buffer size is chosen. In other situations, a reservation for a datarate less than the desired datarate of the content object is made and the buffer size required is determined such that the content object can be played from beginning to end without interruption.

In some circumstances, the user may further decide that a delayed start is not acceptable in step 940. The user can accept “best efforts” delivery in step 942 and receive the content object in step 922. In “best efforts” mode, there may be skips and other QOS issues experienced during playback. The user would always have the option of pausing playback when QOS deteriorates too far such that buffering is done. Resuming playback after buffering in pause mode results in better QOS. If the user decides that “best efforts” mode is not desired back in step 942, a busy message is displayed in step 944.

In some embodiments, a service plan for the content receiver 216 may limit the amount of bandwidth that can be reserved. Different service levels could allow for differing amounts of reserved bandwidth. These service levels could correspond to service tiers. Various service levels could limit the reservation authority of the user based upon the time of day requested for the reservation, the length of reservation, the bandwidth requested for the reservation, how many other reservations are pending, total time requested for other pending reservations, prioritization of all reservations, etc. Further, the service levels could restrict the duration and/or data rate that can be reserved. Some embodiments could impose a charge to the content receiver 216 for each reservation made, the bandwidth reserved, the length of time for the reservation and/or the amount used of the reserved bandwidth.

The above embodiment attempts to reserve bandwidth as the content object is requested. Other embodiments could allow the user to reserve bandwidth for use at a particular future time. For example, a two-hour block of bandwidth could be reserved for 8:00 on Saturday night in anticipation of watching a movie. In an alternative example, a live event could be selected from a program guide for viewing at the top of the hour.

Some embodiments may include the facilities to record performance statistics. These statistics could include success rate in receiving the content object, bandwidth usage per reservation, actual wait time before receiving a reservation versus expected wait time, actual versus granted bandwidth for a reservation, duration of delayed start, rate at which a content object viewing session is abandoned by users, etc. Information such as this could be used for the purposes of billing, maintenance, capacity engineering, etc.

A number of variations and modifications of the invention can also be used. For example, a reservation for bandwidth may be enlarged in period to accommodate pausing and rewinding of the content object during playback. Other embodiments may buffer the remainder such that the reservation period can remain the same. In still other embodiments, the reserved data rate between a headend and a content receiver can dynamically change along with the encoded bitrate within defined QOS ranges.

In the above embodiments, a HFC or HFTP plant is used to distribute the streamed objects to the set top boxes or client computers that play the streamed objects. Other embodiments could use other distribution plants. For example, a wireless plant could be used that provides wireless data transmission using UHF, microwave, satellite, cellular, or other wireless technologies.

While the principles of the invention have been described above in connection with specific apparatuses and methods, it is to be clearly understood that this description is made only by way of example and not as limitation on the scope of the invention.

What is claimed is:

1. A method for distributing a content object over a broadband connection to an end-user location, the method comprising step of:
determining an amount of bandwidth for adequate quality of service (QOS) to transport the content object;
determining a period for transporting the content object;
checking for availability of the amount of bandwidth to the end-user location over the period;
reserving the bandwidth if available; and
streaming the content object to the end-user location.

2. The method for distributing the content object over the broadband connection to the end-user location as recited in claim 1, further comprising a step of beginning to buffer the content object before the streaming step.

3. The method for distributing the content object over the broadband connection to the end-user location as recited in claim 1, further comprising a step of beginning to cache the content before the streaming step.

4. The method for distributing the content object over the broadband connection to the end-user location as recited in claim 1, further comprising a step of converting the content object to a lower bitrate if the check for availability is unsuccessful.

5. The method for distributing the content object over the broadband connection to the end-user location as recited in claim 1, further comprising a step of determining if a lower QOS is acceptable to an end-user if the check for availability is unsuccessful.

6. The method for distributing the content object over the broadband connection to the end-user location as recited in claim 1, further comprising steps of:
determining the amount of bandwidth available over the period, where the amount of bandwidth is less than that required for adequate QOS;
determining a buffer amount to provide adequate QOS; and
storing the buffer amount corresponding to a portion of the content object proximate to the end user location.

7. The method for distributing the content object over the broadband connection to the end-user location as recited in claim 1, further comprising a step of determining usage by the end-user location based upon at least one of a number of reservations made, an amount of bandwidth reserved, a length of a reservation, and a portion of bandwidth used for the amount of bandwidth reserved.

8. A method for distributing a content object over a broadband connection to an end-user location, the method comprising step of:
determining an amount of bandwidth for adequate quality of service (QOS) to transport the content object;
determining a period for transporting the content object;
checking for availability of the amount of bandwidth to the end-user location over the period;
reserving the bandwidth if available;
choosing a lower bitrate version of the content object if the check for availability is unsuccessful; and
streaming the content object to the end-user location.

9. The method for distributing the content object over the broadband connection to the end-user location as recited in claim 8, further comprising a step of beginning to buffer the content object before the streaming step.

10. The method for distributing the content object over the broadband connection to the end-user location as recited in claim 8, further comprising a step of beginning to cache the content before the streaming step.

11. The method for distributing the content object over the broadband connection to the end-user location as recited in claim 8, further comprising a step of determining if a lower QOS is acceptable to an end-user if the check for availability is unsuccessful.

12. The method for distributing the content object over the broadband connection to the end-user location as recited in claim 8, further comprising steps of:
determining the amount of bandwidth available over the period, where the amount of bandwidth is less than that required for adequate QOS;
determining a buffer amount to provide adequate QOS; and
storing the buffer amount corresponding to a portion of the content object proximate to the end user location.

13. The method for distributing the content object over the broadband connection to the end-user location as recited in claim 8, further comprising a step of reserving the bandwidth at a future time.

14. The method for distributing the content object over the broadband connection to the end-user location as recited in claim 8, further comprising a step of checking the service plan associated with the end-user location before allowing the reserving of bandwidth.

15. The method for distributing the content object over the broadband connection to the end-user location as recited in claim 8, further comprising a step of checking the service tier associated with the end-user location before allowing the reserving of bandwidth.

16. The method for distributing the content object over the broadband connection to the end-user location as recited in claim 8, further comprising a step of converting the content object into versions that have different bit rates.

17. A software product embodied on a computer-readable medium for distributing a content object over a broadband connection to an end-user location, the software product comprising code for:
determining an amount of bandwidth for adequate quality of service (QOS) to transport the content object;
determining a period for transporting the content object;
checking for availability of the amount of bandwidth to the end-user location over the period;
reserving the bandwidth if available;
converting the content object to a lower bitrate if the check for availability is unsuccessful; and
streaming the content object to the end-user location.

18. The software product embodied on a computer-readable medium for distributing the content object over the broadband connection to the end-user location as recited in claim 17, further comprising code for beginning to buffer the content object before the streaming step.

19. The software product embodied on a computer-readable medium for distributing the content object over the broadband connection to the end-user location as recited in claim 17, further comprising code for beginning to cache the content before the streaming step.

20. The software product embodied on a computer-readable medium for distributing the content object over the broadband connection to the end-user location as recited in claim 17, further comprising code for determining if a lower QOS is acceptable to an end-user if the check for availability is unsuccessful.

21. The software product embodied on a computer-readable medium for distributing the content object over the broadband connection to the end-user location as recited in claim 17, further comprising code for:
determining the amount of bandwidth available over the period, where the amount of bandwidth is less than that required for adequate QOS;
determining a buffer amount to provide adequate QOS; and
storing the buffer amount corresponding to a portion of the content object proximate to the end user location.
